(19) United States
(12) Patent Application Publication
(10) Pub. No.: US 2006/0069452 A1
(43) Pub. Date: Mar. 30, 2006

(54) Configuration of modules in automation systems

(75) Inventors: Alexander Pfister, Eggolsheim (DE); Michael Tiegelkamp, Pyrbaum (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/233,313

(22) Filed: Sep. 22, 2005

(30) Foreign Application Priority Data
Sep. 29, 2004 (EP) 04023200.1

(51) Int. Cl. G05B 11/01

(52) U.S. Cl. 700/18; 700/19; 700/20

(57) ABSTRACT

The invention relates to an automation system consisting of a plurality of modules and to a method for configuring the modules within the automation system. In order to achieve a simple and operationally reliable configuration of the automation system, the modules are interconnected via interfaces in a hierarchical structure. Hierarchically higher-ranking modules can access description files and device drivers of hierarchically lower-ranking modules and configure the lower-ranking modules on the basis of the information contained in the description files, with each module being itself the storage location of its respective device driver and its description file.

### CROSS REFERENCE TO RELATED APPLICATIONS

This application claims priority to the European application No. 04023200.1, filed Sep. 29, 2004 and which is incorporated by reference herein in its entirety.

### FIELD OF INVENTION

The invention relates to an automation system consisting of a plurality of modules and to a method for configuring the modules within the automation system.

### SUMMARY OF THE INVENTION

Automation systems frequently comprise a very large number of diverse modules or automation devices. Generally, automation systems of said type and the associated modules are configured by means of an engineering system. Said engineering system is for example a personal computer or a programming device on which a software tool suitable for programming programmable logic controllers is installed.

Owing to the very high number and diversity of the supported modules on the automation system side there is accordingly a high degree of complexity on the engineering system side, since all types and variants of modules together with their dynamic behavior must be known therein.

Various interface technologies are currently used within the overall system: description files which describe the modules as GSD, XML or proprietary files, as well as service descriptions such as, for example, software drivers or FDT/DTM which complement the functionality of the engineering system.

Plug-and-play mechanisms such as UPnP, Jini etc. are currently establishing themselves in the PC and networked home device market. Said mechanisms serve to facilitate the configuration of systems. New modules are detected by a higher-ranking host. For this purpose a new module contains an identification code with the aid of which the host can identify the type of the module and load a suitable driver provided the latter is made available by the operating system.

DE 102 12 130 A1 discloses a device for data transmission for a technical system wherein a controller is provided for updating and transmitting driver components, said controller being used to control a data exchange via a data transmission unit with a plurality of peripheral modules connected thereto. An associated driver component is assigned to the respective peripheral module for the purpose of data exchange with the controller, the respective peripheral module being embodied in such a way that when it is connected to the data transmission unit the driver component can be transmitted to the controller.

The object of the invention is to specify an automation system that is easy to configure so as to be operationally reliable, as well as a method for easy and operationally reliable configuration of an automation system.

This object is achieved by an automation system having at least a first and at least a second module, wherein the two modules are related to each other in a hierarchical structure and the first module has at least one hierarchically downward-directed interface and the second module has
at least one hierarchically upward-directed interface,
at least one description file containing information relating to the second module and
at least one device driver which enables the second module to be accessed by the first module or a hierarchically peer-ranking or higher-ranking module to the first module,
   wherein the hierarchically downward-directed interface of the first module can be linked to the hierarchically upward-directed interface of the second module in such a way that the device driver and the description file of the second module can be accessed by the first module or a hierarchically peer-ranking or higher-ranking module to the first module and a configuration of the second module by the first module or a hierarchically peer-ranking or higher-ranking module to the first module is provided.

This object is further achieved by a method for configuring an automation system having at least a first and at least a second module, wherein the two modules are related to each other in a hierarchical structure and the first module has at least one hierarchically downward-directed interface and the second module has
at least one hierarchically upward-directed interface,
at least one description file containing information relating to the second module and
at least one device driver which enables the second module to be accessed by the first module or a hierarchically peer-ranking or higher-ranking module to the first module,
   wherein the hierarchically downward-directed interface of the first module can be linked to the hierarchically upward-directed interface of the second module in such a way that the device driver and the description file of the second module are accessed by the first module or a hierarchically peer-ranking or higher-ranking module to the first module and the second module is configured by the first module or a hierarchically peer-ranking or higher-ranking module to the first module.

The modules of the automation system according to the invention are capable of mutual administration among themselves. For this purpose the individual modules, which are related to one another in a hierarchical structure, have hierarchically upward-directed and/or hierarchically downward-directed interfaces via which a data flow is made possible between the individual modules.

In addition, at least some of the modules of the automation system according to the invention include the device driver that is required for operation of the respective module and the description file. The description file stored on the second module describes the second module in the form of a GSD, XML or proprietary file. Included among the data stored here is configuration information relating to the second module.

The first module is hierarchically superior in rank to the second module within the automation system according to the invention. The configuration information stored in the description file can be read in by the first module or a hierarchically peer-ranking or higher-ranking module to the first module. This enables the first module to administer the second module. The first module can therefore be regarded as the master and the second module as the slave. The synonyms master and slave will therefore also be used in the following description to denote the first and the second module.

The master can, for example, perform the configuration or, as the case may be, the parameterization of the slave when the slave is attached to the automation system. As soon as the slave is connected to a bus assigned to the automation system, it signs on with the first module, the master. When it does so, however, the master experiences no disruption in its cyclical operation. As soon as the master detects the new slave and the cyclical operation of the master within the automation system allows, the master accesses the description file of the slave in order to obtain the information relating to the second module that is necessary in order to configure the slave. Likewise taking into account the disruption-free operation of the automation system, the master module subsequently configures the slave on the basis of the information stored in the description file. Only then does the slave become active within the automation device.

A decisive advantage of the automation system according to the invention is the configuration of the slave module under the control of the master module. After it has been connected to the bus of the automation system, the slave module initially remains passive. An automatic transmission of the description file or the device driver, were it to be triggered by the slave, is undesirable in particular in the automation environment, since this would cause a load to be produced on the bus which would jeopardize disruption-free operation of the automation system. For this reason, in the automation system according to the invention, the configuration of the slave is performed by a higher-ranking module that is already in operation, namely the master or a hierarchically peer-ranking or higher-ranking module to the master. The master or, as the case may be, the hierarchically peer-ranking or higher-ranking module to the master first checks whether the new lower-ranking module is having a disrupting effect on the updating of data and communication of the modules that are already in operation. In certain situations the change to the configuration initiated with the addition of the new module, the slave, will be rejected, or it will be possible to perform the change only in conjunction with a manual intervention by a user.

The master or, as the case may be, the hierarchically peer-ranking or higher-ranking module to the master can have for example a controller for the automation system. In the automation environment specifically it is also possible for a plurality of controllers to be involved in the overall system. In this instance the responsibility for configuring the slave can in principle be assigned to any controller, in which case said controller may also be ranked several hierarchical levels above the slave within the automation system. It is also conceivable that a plurality of controllers are involved in the configuration of the slave.

In particular when the second module and/or modules hierarchically peer-ranking with and/or modules hierarchically inferior to the second module have no dedicated processing unit of their own such as, for example, a controller, it is expedient that the first module has a processing unit that is provided for executing the device driver of the second module and/or of modules hierarchically peer-ranking with and/or modules hierarchically inferior to the second module.

In an advantageous embodiment of the automation system according to the invention the second module has a further processing unit that is provided for executing the device driver of the second module. In this case the device driver does not have to be loaded into a hierarchically higher-ranking module by the second module, but can be executed directly on the further processing unit, which forms a component of the second module, for example a controller. A configuration of modules with and without their own dedicated processing unit within the automation system is of course also possible and encompassed within the scope of the invention.

In an advantageous embodiment of the invention the first module has a generic device driver which can be adapted to the second module and/or to a peer-ranking and/or inferior module to the second module. In this case no device driver at all needs to be installed on the second module or, as the case may be, on a peer-ranking and/or inferior module thereto. The generic device driver can be adapted to said lower-ranking module through evaluation of the description file of the module that is lower in rank to the first module.

In particular when the second module has no dedicated processing unit of its own it is advantageous that the description file and/or the device driver of the second module can be loaded into the first module or into a hierarchically peer-ranking or higher-ranking module to the first module. In this case the corresponding device drivers of the second module are executed by a module placed hierarchically higher in rank to the second module within the automation system.

The automation system according to the invention is of course in no way limited to two hierarchical levels. In particular in an embodiment of the automation system according to the invention having three or more hierarchical levels it is expedient that the second module has at least one further hierarchically downward-directed interface via which the second module can be linked to a third module having
at least one further hierarchically upward-directed interface
at least one further description file containing information relating to the third module and
at least one device driver which enables the second module or a hierarchically peer-ranking or higher-ranking module to the second module to access the third module,
   and a configuration of the third module by the second module or a hierarchically peer-ranking or higher-ranking module to the second module is provided.

In this embodiment according to the invention the third module too can additionally have at least one further hierarchically downward-directed interface via which the third module can finally be linked to a fourth module having at least one further hierarchically upward-directed interface and a configuration of the fourth module by the third module or a hierarchically peer-ranking or higher-ranking module to the third module is provided. Equally, the fourth module can have a description file containing information relating to the fourth module and a device driver which enables access to the fourth module. In this way an arbitrary hierarchical nesting of modules is possible and encompassed within the scope of the invention.

In this embodiment of the invention the second module fulfills both a master role, i.e. in relation to the third module or, as the case may be, a peer-ranking or lower-ranking module to the third module, and a slave role, i.e. in relation to the first module or a hierarchically peer-ranking or higher-ranking module to the first module. In the dynamic execution of the automation system, the second module does not sign on with the first module or a hierarchically peer-ranking or higher-ranking module to the first module, for example, until after the second module has taken over control of the configuration of all lower-ranking modules.

The parameterization of the first module or of a hierarchically peer-ranking or higher-ranking module to the first module is advantageously handed on via the second module to the third module or a hierarchically peer-ranking or higher-ranking module to said third module. A modification of the parameterization of the third module necessary for the operation of the lower-ranking modules can be performed autonomously by the second module.

The configuration of the third module does not necessarily have to be performed by the second module, that is to say that module placed directly above the third module in the hierarchy. The third module can also be configured by the first module or a module situated even higher hierarchically within the automation system.

In an advantageous embodiment of the invention the first module can be linked to an engineering system that is provided for programming and configuring the automation system. The controllers of the modules can be programmed and the controller-side hardware configured with the aid of the engineering system. Moreover the engineering system is suitable for commissioning, troubleshooting and maintenance of the automation system.

During the configuration of an automation system that in reality has not yet been constructed or not yet been fully constructed, software modules can usefully be employed to represent the modules to be deployed later in the project management and configuration phase. These respresentatives should as far as possible be identical with the actual modules in respect of the executed function.

In an advantageous embodiment of the automation system according to the invention the second module and/or the third module can be installed during ongoing operation of the automation system, a commissioning of the second and/or the third module by a module hierarchically higher in rank to the respective module being provided. As soon as the second or the third module is connected to the bus system, the first module, for example, handles its commissioning. However, a prerequisite for a commissioning of the new module is that the cyclical operation of the first module and also the operation of the automation system are not disrupted. This is checked in particular by the first module prior to the commissioning.

The invention will be described and explained in more detail below with reference to the exemplary embodiments depicted in the figures.

### BRIEF DESCRIPTION OF THE DRAWINGS

FIG. 1 shows a configuration of two modules within an automation system,

FIG. 2 shows an embodiment of an automation system according to the invention having three hierarchical levels and an engineering system,

FIG. 3 shows a second module 2 communicating with a higher-ranking first module and a lower-ranking third module, and

FIG. 4 shows a multicontroller automation system.

### DETAILED DESCRIPTION OF THE INVENTION

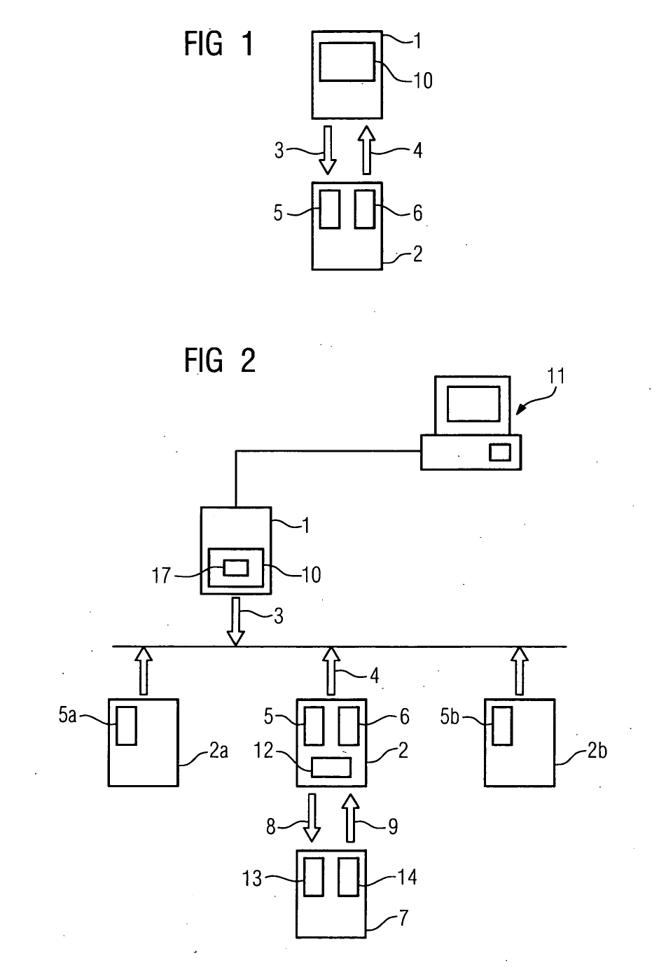

FIG. 1 shows a configuration of two modules 1, 2 within an automation system in an embodiment according to the invention. A first module 1 has a hierarchically downward-directed interface 3 and a second module 2 has a hierarchically upward-directed interface 4. The two modules 1, 2 are linked to each other via said interfaces 3, 4 in order to enable a data flow between the two modules 1, 2. The first module 1 is arranged hierarchically above the second module 2 within the automation system.

The second module 2 comprises firstly a description file 5 in which information relating to the second module 2 is stored. Secondly, the second module 2 has a device driver 6 which enables operation of the second module 2 within the automation system. In addition, data serving for self-identification of the second module 2 as well as parameter data can be stored on the second module 2. The description file 5, the device driver 6, the parameters and the data for self-identification can be encompassed by a software component referred to in the following as a module handler. The first module 1 can, of course, also have a module handler of said kind.

The first module 1 further has a processing unit 10. If, for example, the second module 2 is connected to the first module 1, the second module 2 initially signs on to the bus within the automation system. The first module 1 registers this sign-on and accesses the description file 5 of the second module 2. The sign-on to the bus and the access to the description file 5 always take place subject to the condition that the cyclical operation of the automation system is not disrupted by these actions.

Next, the first module 1 configures the second module 2 with the aid of the information from the description file 5. The device driver 6 is loaded into the processing unit 10 of the first module 1 and the second module 2 is placed into operation as a slave of the first module 1.

Alternatively, however, a generic device driver can also be present on the first module 1, by means of which generic driver the second module 2 can be operated. For this purpose the generic driver of the first module 1 initially evaluates the description file. In this case the second module 2 does not necessarily have to possess its own dedicated driver and consequently also does not have to load same via the bus into the first module 1.

FIG. 2 shows an embodiment of an automation system according to the invention having three hierarchical levels and an engineering system 11. A first module 1 serves as master of the overall automation system and consequently is situated at the highest hierarchical level. For the purpose of configuring the automation system the master 1 is connected to the engineering system 11, by means of which a user can gain manual access to the overall system, for example for project management and configuration purposes.

Located within the master is a processing unit 10, which shall also be referred to in the following as a controller. The controller 10 can contain, for example, a generic driver 17 by means of which lower-ranking modules 2, 2a, 2b, 7 can be operated. For this purpose the master 1 initially accesses description files 6, 6a, 6b, 13 of lower-ranking modules. Alternatively, however, the lower-ranking modules 2, 2a, 2b, 7 can also have their own dedicated processing units by means of which the device drivers of the respective modules or modules hierarchically lower-ranking than the respective modules are executed. This is shown by way of example in the drawing for a second module 2 which has a further processing unit 12 as well as a device driver 6 and the description file 5. The module executes its device driver 6 using the further processing unit 12.

Located on the second hierarchical level in addition to the second module 2 are also two further modules 2a, 2b, peer-ranking to the second module, which are administered by the master 1 or, as the case may be, the controller 10 of the master 1.

As well as a hierarchically upward-directed interface 4, the second module 2 also has a hierarchically downward-directed interface 8. The second module 2 is connected via the hierarchically downward-directed interface 8 to a further hierarchically upward-directed interface 9 of a third module 7. The third module 7 has in turn a further description file 13 for describing the third module 7 and a further device driver 14. The third module 7 is administered by the second module 2.

If the third module 7 is connected for example subsequently to the automation system, the third module 7 initially signs on with the second module 2. The second module 2 then handles the configuration of the third module 7 on the basis of the information relating to the third module 7 in the further description file 13. During this process, cyclical operations within the automation system have a higher priority in order to ensure disruption-free operation of the overall system.

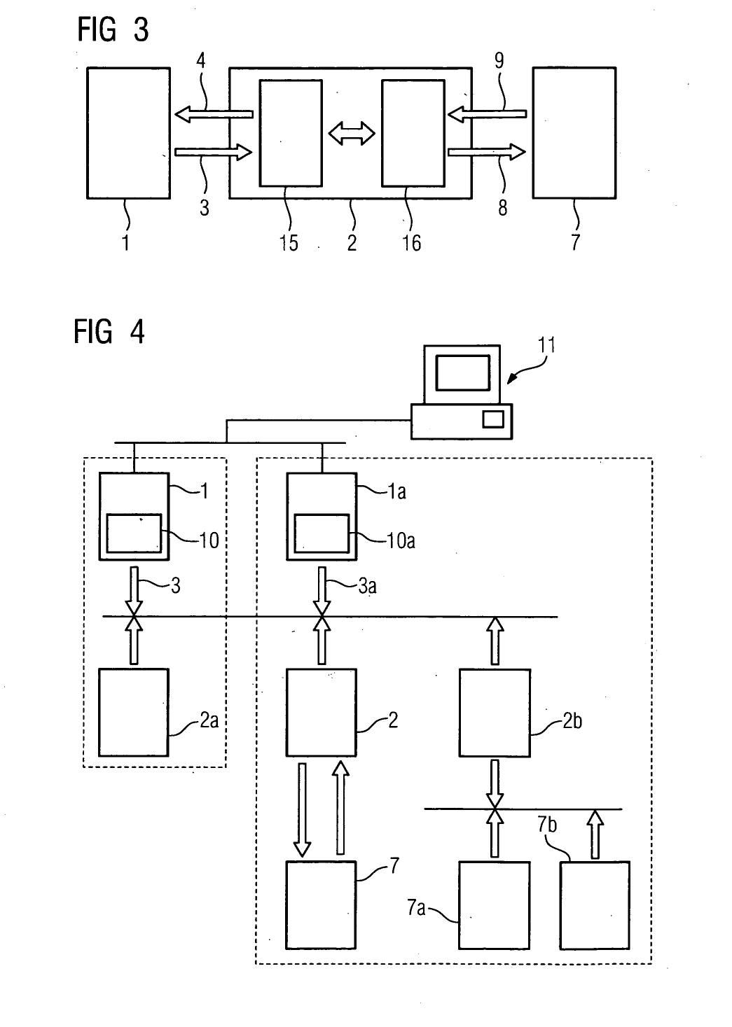

FIG. 3 shows a second module 2 communicating with a higher-ranking first module 1 and a lower-ranking third module 7. In this inventive configuration of modules within an automation system, the first module 1 fulfills the function of a master and the third module the function of a slave. The second module 2 can be regarded as a slave/master module and represents a link between the hierarchical level of the master 1 and the slave 7 by compressing data which originates from modules on the hierarchical level of the slave 7 in the upward direction.

The particular feature of the slave/master module 2 is that it has a slave component 15 and a master component 16, the slave component 15 acting as representative for all lower-ranking modules. In the exemplary embodiment depicted, only the third module 7 is drawn in for the lower-ranking hierarchical level below the slave/master module 2. Further modules can, of course, also be arranged as peer-ranking or lower-ranking to the third module 7, all of which are represented by the slave/master module 2 in the direction of the master 1. During a configuration of the system or, as the case may be, its modules, the slave component 15 does not sign on with the higher-ranking master 1 until it has taken over all the information of the lower-ranking modules.

A parameterization of the lower-ranking modules is passed on by the higher-ranking master 1 via the slave/master module 2 to the lower-ranking third module 7 or, as the case may be, to modules peer-ranking or lower-ranking to the third module. The master component 16 of the slave/master module 2 can autonomously carry out modifications that are necessary for the operation of the lower-ranking modules.

FIG. 4 shows a multicontroller automation system. In this embodiment according to the invention, a first module 1 and a module 1a peer-ranking to the first module are disposed on the highest hierarchical level of the automation system, each of the two modules 1, 1a having its own dedicated processing unit 10, 10a. The processing units 10, 10a are also referred to in the following as controllers and the first module 1 and its peer-ranking module 1a as master modules.

Hierarchically lower in rank to the master modules 1, 1a are a second module 2 and modules 2a, 2b peer-ranking to the second module 2. The second module 2 is linked to a third module 7 which is hierarchically lower in rank to the second module 2. Said module fulfills the function of a slave/master module according to the statements made with reference to FIG. 3. One module 2a peer-ranking to the second module 2 is a slave module and the other module 2b peer-ranking to the second module 2 is a further slave/master module. Two further third modules 7a, 7b are lower in rank than the further slave/master module 2b. The information flow from the modules 7a, 7b peer-ranking to the third module is compressed to a responsible controller by the further slave/master module 2b in the direction of the highest hierarchical level.

With the aid of an engineering system 11, a user can determine the assignment of the lower-ranking modules 2, 2a, 2b, 7, 7a, 7b relative to the masters 1, 1a to the masters 1, 1a. When a new module is added during operation, said new module signed on with both masters 1, 1a initially as a new module. However, it remains passive until a unique assignment has been made to one of the masters 1, 1a.

The user decision in respect of to which master 1, 1a a new module is to be assigned can be taken, based on predefined rules, before the system is commissioned so that no user intervention in the ongoing operation of the system will be necessary.

Without predefined rules of said kind, a configuration request by the new module can be passed on successively upwards from its hierarchical level until it is finally made visible to the user for example on the engineering system 11.

To sum up, the invention relates to an automation system consisting of a plurality of modules and to a method for configuring the modules within the automation system. In order to achieve a simple and operationally reliable configuration of the automation system, the modules are interconnected via interfaces in a hierarchical structure. Hierarchically higher-ranking modules can access description files and device drivers of hierarchically lower-ranking modules and configure the lower-ranking modules on the basis of the information contained in the description files, with each module being itself the storage location of its respective device driver and its description file.

1.-16. (canceled)

17. An automation system, comprising:
at least a first module; and
at least a second module, wherein the first and the second modules are related to each other in a hierarchical structure, and wherein the first module has at least one hierarchically downward-directed interface, and wherein the second module comprises:
at least one hierarchically upward-directed interface;
at least one description file containing information relating to the second module; and
at least one device driver which enables the first module or a hierarchically peer-ranking or higher-ranking module to the first module to access the second module, wherein the hierarchically downward-directed interface of the first module can be linked to the hierarchically upward-directed interface of the second module in such a way that the device driver and the description file of the second module can be accessed by the first module or a hierarchically peer-ranking or higher-ranking module to the first module and a configuration of the second module by the first module or a hierarchically peer-ranking or higher-ranking module to the first module is provided.

18. The automation system as claimed in claim 17, wherein the first module further comprises a processing unit for executing the device driver of the second module and/or hierarchically peer-ranking modules to the second module and/or hierarchically lower-ranking modules to the second module.

19. The automation system as claimed in claim 17, wherein the second module further comprises a further processing unit for executing the device driver of the second module.

20. The automation system as claimed in claim 18, wherein the second module further comprises a further processing unit for executing the device driver of the second module.

21. The automation system as claimed in claim 17, wherein the first module further comprises a generic device driver operationally adaptable to the second module and/or a peer-ranking and/or lower-ranking module to the second module.

22. The automation system as claimed in claim 18, wherein the first module further comprises a generic device driver operationally adaptable to the second module and/or a peer-ranking and/or lower-ranking module to the second module.

23. The automation system as claimed in claim 19, wherein the first module further comprises a generic device driver operationally adaptable to the second module and/or a peer-ranking and/or lower-ranking module to the second module.

24. The automation system as claimed in claim 17, wherein the description file and/or the device driver of the second module can be loaded into the first module or a hierarchically peer-ranking or higher-ranking module to the first module.

25. The automation system as claimed in claim 17, wherein the second module comprises at least one further hierarchically downward-directed interface via which the second module can be linked to a third module, the third module comprising:
at least one further hierarchically upward-directed interface;
at least one further description file containing information relating to the third module; and
at least one device driver which enables the second module or a hierarchically peer-ranking or higher-ranking module to the second module to access the third module, wherein a configuration of the third module by the second module or a hierarchically peer-ranking or higher-ranking module to the second module is provided.

26. The automation system as claimed in claim 17, wherein the first module can be linked to an engineering system provided for the purpose of programming and configuring the automation system.

27. The automation system as claimed in claim 17, wherein the second module and/or the third module can be installed during ongoing operation of the automation system, a commissioning of the second and/or the third module by a hierarchically higher-ranking module to the respective module being provided.

28. A method for configuring an automation system having at least a first and at least a second module, wherein the two modules are related to each other in a hierarchical structure and the first module has at least one hierarchically downward-directed interface and the second module has
at least one hierarchically upward-directed interface,
at least one description file containing information relating to the second module, and
at least one device driver which enables the second module to be accessed by the first module or a hierarchically peer-ranking or higher-ranking module to the first module, the method comprising:
linking the hierarchically downward-directed interface of the first module to the hierarchically upward-directed interface of the second module in such a way that the device driver and the description file of the second module are accessed by the first module or a hierarchically peer-ranking or higher-ranking module to the first module and that the second module is configured by the first module or a hierarchically peer-ranking or higher-ranking module to the first module.

29. The method as claimed in claim 28, wherein the first module executes the device driver of the second module and/or hierarchically peer-ranking modules and/or hierarchically lower-ranking modules to the second module with the aid of a processing unit.

30. The method as claimed in claim 28, wherein the second module executes the device driver of the second module with the aid of a further processing unit.

31. The method as claimed in claim 28, further comprising:
adapting a generic device driver residing on the first module to the second module and/or a peer-ranking and/or lower-ranking module to the second module.

32. The method as claimed in claim 28, wherein the description file and/or the device driver of the second module are/is loaded into the first module or a hierarchically peer-ranking or higher-ranking module to the first module.

33. The method as claimed in claim 28, wherein the second module comprises at least one further hierarchically downward-directed interface via which the second module is linked to a third module, the third module having:
at least one further hierarchically upward-directed interface,
at least one further description file having information relating to the third module, and
at least one device driver which enables the third module to be accessed by the second module or a hierarchically peer-ranking or higher-ranking module to the second module, wherein
the third module is configured by the second module or a hierarchically peer-ranking or higher-ranking module to the second module.

34. The method as claimed in claim 28, wherein the first module is linked to an engineering system and the automation system is programmed and configured by the engineering system.

35. The method as claimed in claim 28, wherein the second module and/or the third module is installed during ongoing operation of the automation system, wherein the second and/or the third module are placed into operation by a hierarchically higher-ranking module to the respective module.
